(19) United States
(12) Patent Application Publication
(10) Pub. No.: US 2013/0126199 A1
(43) Pub. Date: May 23, 2013

(54) CONTROLLED IMPACT RESCUE TOOL IMPACT ELEMENT

(71) Applicants: Luis Giraldo, Fairfax, VA (US); Benjamin Dolgin, Alexandria, VA (US); John Ryan, Fairfax, VA (US); Michael Millspaugh, Burke, VA (US); Edward Dezelick, Germantown, MD (US)

(72) Inventors: Luis Giraldo, Fairfax, VA (US); Benjamin Dolgin, Alexandria, VA (US); John Ryan, Fairfax, VA (US); Michael Millspaugh, Burke, VA (US); Edward Dezelick, Germantown, MD (US)

(73) Assignee: Raytheon Company, Waltham, MA (US)

(21) Appl. No.: 13/303,645

(22) Filed: Nov. 23, 2011

(51) Int. Cl. B25D 9/02

(52) U.S. Cl. 173/90

(57) ABSTRACT

An impact element is provided and includes a single body drivable into an external element by force acting on a piston head. The single body includes a head and a shaft having a first end integrally coupled to the head, a second end opposite the first end and a central portion interposed between the first and second ends. The second end of the shaft is operatively connectable with the piston head to define a joint located remotely from the head. The first end of the shaft has a trailing portion with a diameter similar to that of the central portion, a leading portion with a diameter similar to that of the rear end of the head and a taper from the trailing portion to the leading portion.

### BACKGROUND

The subject matter disclosed herein relates to an impact element and, more particularly, to an impact element of a controlled impact rescue tool (CIRT).

Urban search and rescue teams often need to create openings (called “breaches”) in rigid structures, such as reinforced concrete walls, to reach victims in buildings after a disaster, such as an earthquake or a hurricane. To facilitate the search and rescue effort, breaching equipment should be portable, easy to operate and rapid in effect while not destabilizing the building structure or threatening injury to operators or victims.

Techniques for breaching concrete walls often include gasoline and hydraulic powered diamond chain saws, gasoline and hydraulic powered circular saws, diamond wire saws, large bore corers, hydraulic/pneumatic/electric impact tools, water jets and hydraulic splitters. These techniques all typically require several hours to breach a thick, heavily reinforced concrete wall and the equipment may not be portable in some instances. Military teams also use explosives to quickly breach walls, but this is dangerous to victims and can destabilize the structure. Lasers have also been proposed for breaching applications, but size, safety and power constraints generally make them infeasible.

Accordingly, devices and methods are needed that address one or more of the aforementioned shortcomings of conventional reinforced concrete breaching devices and methods. U.S. Pat. No. 7,814,822 thus proposed to provide an impact element and a self-contained energy source. The self-contained energy source enables the impact element to impact a first surface of a structure. The impact element is configured to transmit a localized shock wave through the structure upon impact. The self-contained energy source is capable of accelerating the impact element to a velocity sufficient to induce spalling at a second surface of the structure.

### SUMMARY

According to one aspect of the invention, an impact element is provided and includes a single body drivable into an external element by force acting on a piston head. The single body includes a head and rear ends and a shaft having a first end integrally coupled to the head, a second end opposite the first end and a central portion interposed between the first and second ends. The second end of the shaft is operatively connectable with the piston head to define a joint located remotely from the head. The first end of the shaft has a trailing portion with a diameter similar to that of the central portion, a leading portion with a diameter similar to that of the rear end of the head and a taper from the trailing portion to the leading portion.

According to another aspect of the invention, a breaching apparatus is provided and includes a housing defining a tunnel and including a piston head movable through the tunnel between a loaded position and a fired position and a biasing unit configured to bias the piston head to remain in the loaded position, a firing mechanism configured to overcome the bias to move the piston head toward the fired position and a single body impact element drivable by the movement of the piston head into an external element. The single body impact element includes a head and a shaft having a first end integrally coupled to the head, a second end opposite the first end, which is operatively connectable with the piston head to define a joint located remotely from the head, and a central portion interposed between the first and second ends. The central portion of the shaft is narrower than a rear of the head, and the first end of the shaft has a taper.

According to yet another aspect of the invention, a breaching apparatus is provided and includes a housing defining a tunnel and including a piston head movable through the tunnel between a loaded position and a fired position and a biasing unit configured to bias the piston head to remain in the loaded position, a firing mechanism configured to overcome the bias to move the piston head toward the fired position and a single body impact element drivable by the movement of the piston head into an external element. The single body impact element includes a head and a shaft having a first end integrally coupled to the head, a second end operatively connectable with the piston head to define a joint located remotely from the head and a central portion interposed between the first and second ends.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a breaching apparatus in accordance with embodiments;

FIG. 2 is a side view of an impact element of the breaching apparatus in accordance with embodiments;

FIG. 3 is an enlarged view of a portion of the impact element of FIG. 2, which is encircled by circle “A”; and

FIG. 4 is an enlarged view of another portion of the impact element of FIG. 2, which is encircled by circle “B”.

The detailed description explains embodiments of the invention, together with advantages and features, by way of example with reference to the drawings.

### DETAILED DESCRIPTION

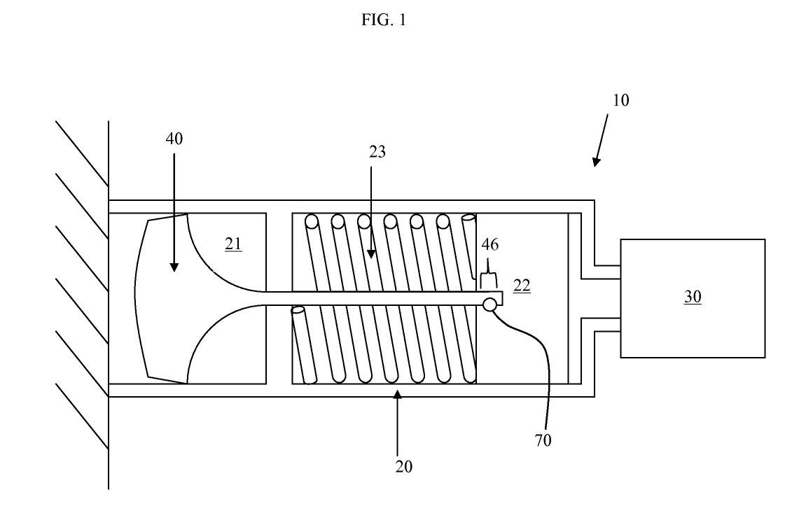

With reference to FIG. 1, a controlled impact rescue tool (CIRT) 10 is provided. The CIRT 10 is described in detail in U.S. Pat. No. 7,814,822, the entire contents of which are incorporated herein by reference. As a general matter, the CIRT 10 includes a housing 20, a firing mechanism 30 and a single body impact element 40. The housing 20 is formed to define a tunnel 21 and includes a piston head 22 and a biasing unit 23. The piston head 22 is movable through the tunnel 21 between a loaded position, at which the piston head 22 is prepared to be fired, and a fired position, at which the piston head 22 is located following a selective firing operation and subsequent impact. The biasing unit 23 is configured to bias the piston head 22 to remain in the loaded position until a selective firing operation occurs. The biasing unit 23 may include an elastic element, such as a spring, and may further include a temporary lock that is engageable with the piston head 22 disposed in the loaded position such that undesirable movement of the piston head 22 out of the loaded position may be prevented.

The firing mechanism 30 is responsible for the executing the selective firing operation against the bias of the biasing unit 23 and, where applicable, the temporary lock. The firing mechanism 30 may be operated by a pneumatic device, by internal combustion of high explosives within the tunnel 21 and/or by another similar configuration. For purposes of clarity and brevity, the case of the firing mechanism 30 being operable by combustion of high explosives within the tunnel 21 will be described herein but, as a general matter, the firing mechanism 30 is configured to apply force to the piston head 22 to overcome the bias provided by at least the biasing unit 23 to thereby move the piston head 22 at, in some cases, high speed toward the fired position.

The single body impact element (the “impact element”) 40 is connectable to the piston head 22 and is thereby drivable by the movement of the piston head 22 into an external element, such as a concrete wall to be breached by the CIRT 10. Since the combustion of the high explosives within the tunnel 21 may provide substantial kinetic energy to the piston head 22, the impact element 40 is thereby drivable with relative very high velocity toward the external element.

Thus, the CIRT 10 is configured to harness energy released by heated gases produced by the firing mechanism 30 to push onto a rear face of the piston head 22 such that the piston head 22 and the impact element 40 move as a unit and acquire the kinetic energy required to produce damage on the external element (i.e., the concrete wall intended to be breached). Further, a shock wave may be produced in both the concrete wall and the impact element 40 during impact. The shock wave in the concrete wall is intended to cause localized damage and eventually produce a breach. The shock wave traveling through the impact element 40 may cause cyclical loading that could damage the impact element 40. To this end, the impact element 40 has been provided with features that result in longer life, reduced jamming and added reliability, as will be described below.

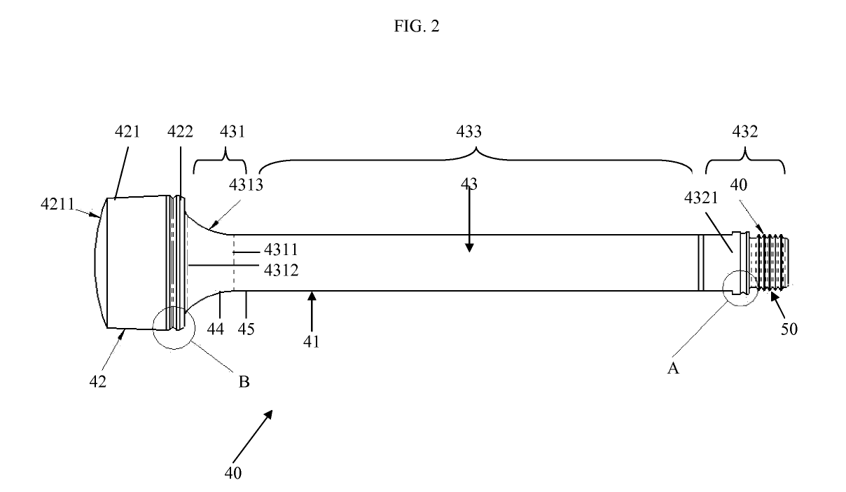

With reference to FIGS. 2-4, the impact element 40 includes a single body 41, which is drivable into the concrete wall. The single body 41 includes a head 42 and a shaft 43. The head 42 has a frusto-conical shape with a front end 421 that is disposable in a leading position and a rear end 422, which opposes the front end 421 and is disposable in a trailing position. The front end 421 may include a domed surface 4211 that produces the shock wave in the concrete wall. The radius of the dome surface 4211 can be optimized to promote self-alignment of the shaft 43 during operation to lengthen a lifetime of the shaft 43.

The shaft 43 has a first end 431, which is integrally coupled to the rear end 422, a second end 432, which is opposite the first end 431 and a central portion 433. The central portion 433 is interposed between the first end 431 and the second end 432 and includes an elongate member that extends along a longitudinal axis of the impact element 40 and, in some cases, the tunnel 21 when the impact element 40 is disposed therein. The central portion 433 of the shaft 43 has a narrower diameter than the rear end 422. The first end 431 of the shaft 43 has a trailing portion 4311 with a diameter that is similar to that of the central portion 433, a leading portion 4312 with a diameter that is similar to that of the rear end 422 and a taper 4313 that extends from the trailing portion 4311 to the leading portion 4312. The taper 4313 may be curvilinear or gradual and, at least in the curvilinear case, the taper 4313 may be characterized as a large radius transition between the central portion 433 and the head 42 and serves as a wave guide for shock waves to reduce stress concentration points at the interface between the first end 431 and the central portion 433 and to thereby increase structural stability.

In accordance with embodiments, the shaft 43 has a smooth exterior surface including exterior surface 44 of the first end 431 and exterior surface 45 of the central portion 433. Exterior surfaces 44 and 45 are adjacent to one another and present a smooth interface from the substantially cylindrical surface of the central portion 433 to the curvilinearly tapered surface of the first end 431. As such, at least stress concentration points are further reduced.

In accordance with further embodiments, the trailing portion 4311 of the first end 431 of the shaft 43 may have the same diameter as the central portion 433 of the shaft 43 thereby providing the smooth interface. By contrast, the leading portion 4312 of the first end 431 of the shaft 43 may have a slightly narrower diameter than the rear end 422.

In accordance with further embodiments, the front end 421 has a narrower diameter than the rear end 422. That is, the head 42 is tapered from the rear end 422 to the front end 421. This improves an ability of the head 42 to be self cleaning and reduces potential for jamming of the head 42 during a firing operation that may result from mechanical interference and/or material accumulation in, for example, the tunnel 21.

In accordance with further embodiments, the second end 432 of the shaft 43 is connectable with the piston head 22. This connection is provided such that the second end 432 cannot be undesirably or otherwise non-selectively disengaged from the piston head 22 under normal conditions. The connection also serves to define a joint 46 between the shaft 43 and the piston head 22 that is located remotely from the head 42. The second end 432 of the shaft 43 has an exterior surface 4321 with threading 50 formed thereon. The threading 50 permits the impact element 40 to be threadably engageable with corresponding threading formed in a recess defined in the piston head 22. That is, the impact element 40 is formed such that the head 42 and the shaft 43 are integrally coupled with one another while the threaded second end 432 for piston head 22 installation is placed remotely from the impact point. This placement of the threading 50 and the resulting definition of the joint 46 being remote from the head 22 may reduce potential for thread failure during at least impact instances.

With the threading 50 provided at the second end 432 of the shaft 43, assembly of the impact element 40 may be performed as follows. In one exemplary embodiment, the impact element 40 and the piston head 22 can be threadably engaged with one another to form an impact element assembly, which is then configured to be installed in the housing 20. In an alternate exemplary embodiment, the piston head 22 is installed in the housing 20 and the impact element 40 is then connected to the piston head 22. In this case, an operator may handle the head 42 and may insert the shaft 43 into the housing 20 through the tunnel 21 such that the shaft 43 eventually encounters the piston head 22. At that point, the operator rotates that impact element 40 about a longitudinal axis thereof to threadably engage the threading 50 at the second end 432 of the shaft 43 with the complementary threading of the piston head 22. As such, it is possible that multiple impact elements 40 can be relatively easily connected to and disconnected from the piston head 22 during the lifetime of the CIRT 10 without requiring removal of the piston head 22 from the housing 20.

It is to be understood that the operative connection between the shaft 43 and the piston head 22 need not be provided by the threading 50 and the complementary threading of the piston head 22. In alternate embodiments, the operative connection may be provided by way of fasteners, snap-fittings, mechanical interlocks and/or other similar devices. In any case, the operative connection must be able to survive impact instances without disconnection failures and should be located remotely from the head 42. In addition, although it is not required, the operative connection should be provided such that the joint 46 is disposed along or radially proximate to the longitudinal axis of the shaft 43. As such, shock waves from impact instances can be transmitted relatively evenly through the joint 46 from the shaft 43 to the piston head 22.

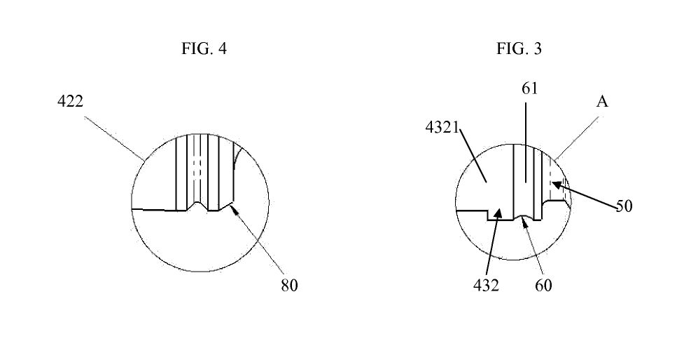

As shown in FIG. 3, the impact element 40 may further include a locking unit 60 disposed at the second end 432 of the shaft 43. In accordance with embodiments, the locking unit 60 may be formed as a peripheral groove 61 extending about the exterior surface 4321 at or near a base of the threading 50. Such a peripheral groove 61 may be engageable with a corresponding fastener, such as a rolled pin 70 (see FIG. 1), to permit locking of the shaft 43 to the piston head 22.

As shown in FIG. 4, the rear end 422 may include a shallow tapered chamfer 80 to promote smooth operation of the CIRT 10 during piston head 22 resetting. While a diameter of a portion of the rear end 422 may be substantially similar to an inner diameter of the tunnel 21 in order to promote secure movement of the impact element 40 through the tunnel, the shallow tapered chamfer 80 is characterized as having a reduced diameter taper with increasing axial distance from the front end 421. As such, mechanical interference during resetting of the impact element 40 or the piston head 22 can be reduced or substantially avoided. In particular, the shallow tapered chamfer 80 may promote reinsertion of the impact element 40 into the tunnel 21 and/or movement of the impact element 40 through the tunnel 21.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

Claims:

1. An impact element, comprising:
a single body drivable into an external element by force acting on a piston head, the single body comprising:
a head; and
a shaft having a first end integrally coupled to the head, a second end opposite the first end and a central portion interposed between the first and second ends,
the second end of the shaft being operatively connectable with the piston head to define a joint located remotely from the head, and
the first end of the shaft having a trailing portion with a diameter similar to that of the central portion, a leading portion with a diameter similar to that of the rear end of the head and a taper from the trailing portion to the leading portion.

2. The impact element according to claim 1, wherein the taper is a curvilinear taper.

3. The impact element according to claim 1, wherein a front end of the head has a narrower diameter than the rear end of the head, the head being tapered from the rear end to the front end.

4. The impact element according to claim 1, wherein a front end of the head comprises a domed surface.

5. The impact element according to claim 1, further comprising threading formed on an exterior surface of the second end of the shaft such that the second end of the shaft is threadably engageable with the piston head.

6. The impact element according to claim 1, further comprising a locking unit disposed at the second end of the shaft.

7. The impact element according to claim 1, wherein the rear end of the head comprises a shallow tapered chamfer.

8. A breaching apparatus, comprising:
a housing defining a tunnel and including a piston head movable through the tunnel between a loaded position and a fired position and a biasing unit configured to bias the piston head to remain in the loaded position;
a firing mechanism configured to overcome the bias to move the piston head toward the fired position; and
a single body impact element drivable by the movement of the piston head into an external element and including:
a head and a shaft having a first end integrally coupled to the head, a second end opposite the first end, which is operatively connectable with the piston head to define a joint located remotely from the head, and a central portion interposed between the first and second ends, the central portion of the shaft being narrower than a rear of the head, and the first end of the shaft having a taper.

9. The breaching apparatus according to claim 8, wherein the taper is a curvilinear taper.

10. The breaching apparatus according to claim 8, wherein the head is tapered.

11. The breaching apparatus according to claim 8, further comprising threading formed on an exterior surface of the second end of the shaft such that the second end of the shaft is threadably engageable with the piston head.

12. The breaching apparatus according to claim 8, further comprising a locking unit disposed at the second end of the shaft.

13. The breaching apparatus according to claim 8, wherein the rear of the head comprises a shallow tapered chamfer.

14. A breaching apparatus, comprising:
a housing defining a tunnel and including a piston head movable through the tunnel between a loaded position and a fired position and a biasing unit configured to bias the piston head to remain in the loaded position;
a firing mechanism configured to overcome the bias to move the piston head toward the fired position; and
a single body impact element drivable by the movement of the piston head into an external element and including a head and a shaft having a first end integrally coupled to the head, a second end operatively connectable with the piston head to define a joint located remotely from the head and a central portion interposed between the first and second ends.

15. The breaching apparatus according to claim 14, wherein the first end of the shaft has a curvilinear taper.

16. The breaching apparatus according to claim 14, wherein respective exterior surfaces of the first end and the central portion of the shaft present a smooth interface.

17. The breaching apparatus according to claim 14, wherein the head is tapered.

18. The breaching apparatus according to claim 14, further comprising threading formed on an exterior surface of the second end of the shaft whereby the shaft is threadably engageable with the piston head.

19. The breaching apparatus according to claim 14, further comprising a locking unit disposed at the second end of the shaft.

20. The breaching apparatus according to claim 14, wherein a rear end of the head comprises a shallow tapered chamfer.
